(19) United States
(12) Patent Application Publication
(10) Pub. No.: US 2024/0099270 A1
(43) Pub. Date: Mar. 28, 2024

(54) Self-Adjusting Pet Leash

(71) Applicants: Lila Behravesh, Atlanta, GA (US); Esfandiar Behravesh, Atlanta, GA (US)

(72) Inventors: Lila Behravesh, Atlanta, GA (US); Esfandiar Behravesh, Atlanta, GA (US)

(21) Appl. No.: 17/935,103

(22) Filed: Sep. 25, 2022

(51) Int. Cl. A01K 27/00

(52) U.S. Cl. CPC A01K 27/003; A01K 27/005

(57) ABSTRACT

A pet leash including a track having a first end and a second end and at least one pet connector having a hook portion and a slider portion that enables the pet connector to move freely along the track.

### FIELD OF THE INVENTION

This disclosure relates to leashes and, more particularly, to a pet leash assembly for simultaneously maintaining a plurality of pets at an untangled position during walking conditions.

### BACKGROUND OF THE INVENTION

Numerous specialty leashes have been developed to assist with walking a plurality of pets at once. However, each of these leash designs suffers from shortcomings. For example, retractable leashes have been designed to allow a handler to control the length of the pet's leash. Retractable leashes, however, suffer from similar problems as basic fixed length leashes that may become crossed or tangled. These leashes further include internal components and mechanisms that are prone to wear and tear. Multiple-pet fixed length leashes allow a handler to tether two pets using just one leash. However, these leashes often do not provide individual control of each pet, and thus allow the pets to both tangle and pull at one another.

Therefore, an improved leash for tethering multiple animals is needed.

### SUMMARY OF THE INVENTION

According to an example a pet leash includes a track including a first end and a second end and at least one pet connector including a hook portion and a slider portion that enables the pet connector to move freely along the track.

In an example, the first end and the second end of the track are connected to one another.

In an example, the first end and the second end of the track are connected to one another via stitching, clips, detachable rings, connector and a corresponding ring, or a combination thereof

In an example, the at least one pet connector includes first pet connector and a second pet connector to create a multi-pet leash.

In an example, wherein one of the first or second pet connectors is removably attached to a portion of the multi-pet leash to convert the multi-pet leash to a single pet leash.

In an example, the slider allows a pet connected to the hook portion of the connector to move freely along the track.

In an example, the leash includes at least one handle.

In an example, the at least one handle is part of the track.

In an example, the at least one handle is separate from the track and is connected to the track by stitch, clip, hook and corresponding ring, swivel connector, or a combination thereof.

In an example, each of the first end of the track includes a first handle and the second end of the track includes a second handle

According to another example of the invention, each of the first handle and the second handle is formed as part of the first end of the track and second end of the track, respectively.

In an example, each of the first handle and the second handle is separate from the track and is connected to its respective first and second end of the track by stitch, clip, hook and corresponding ring, swivel connector, or a combination thereof.

In an example, the pet leash further includes a stopper that limits the movement of at least one pet connector on the track.

In an example, the pet leash further includes a length adjustor.

In an example, the length adjustor comprises a device that overlaps or connects two portions of the track to one another.

In an example, wherein the length adjustor is a buckle, a zipper, elastic band, or a combination thereof.

In an example, a multi-pet leash includes a track portion, a handle portion, and at least two connectors, wherein at least one of the two connectors is a slidable connector.

In an example, the multi-pet leash includes at least one stopper.

In an example, a multi-pet leash includes a track portion having a first end and a second end and a handle associated with each of the first end and the second end.

In yet another example, the multi-pet leash further includes at least two connectors, wherein at least one of the two connectors is a slidable connector.

Additional features and advantages of various examples will be set forth, in part, in the description that follows, and will, in part, be apparent from the description, or may be learned by the practice of various examples. The objectives and other advantages of various examples will be realized and attained by means of the elements and combinations particularly pointed out in the description herein.

### BRIEF DESCRIPTION OF THE DRAWINGS

The drawings described herein are for illustration purposes only and are not intended to limit the scope of this disclosure in any way.

FIG. 1A is a leash for walking multiple pets, in accordance with an example of the present disclosure;

FIG. 1B illustrates the details of the sliding portion of the exemplary connector of FIG. 1, in accordance with an example of the present disclosure;

FIG. 2 is a leash for walking multiple pets having a main body and a handle, in accordance with an example of the present disclosure;

FIG. 3 is a leash for walking multiple pets having a main body, a handle, and a swivel between the main body and the handle, in accordance with an example of the present disclosure;

FIG. 4 is a leash for walking multiple pets having a main body and a detachable handle, in accordance with an example of the present disclosure;

FIG. 5 is a leash for walking multiple pets with a pet controller feature, in accordance with an example of the present disclosure;

FIG. 6 is a leash for walking a single or multiple pets, in accordance with an example of the present disclosure;

FIG. 7 is a leash for walking multiple pets with two handles, in accordance with an example of the present disclosure; and

FIG. 8 is a leash for walking multiple pets with two detachable handles, in accordance with an example of the present disclosure;

Throughout this specification and figures like reference numbers identify like elements.

### DETAILED DESCRIPTION

It is to be understood that both the foregoing general description and the following detailed description are examples and explanatory only, and are intended to provide an explanation of various examples of the present teachings.

Throughout the present disclosure, the terms “a” and “an” are intended to denote at least one of a particular element. As used herein, the term “includes” means includes but not limited to, the term “including” means including but not limited to. The term “based on” means based at least in part on.

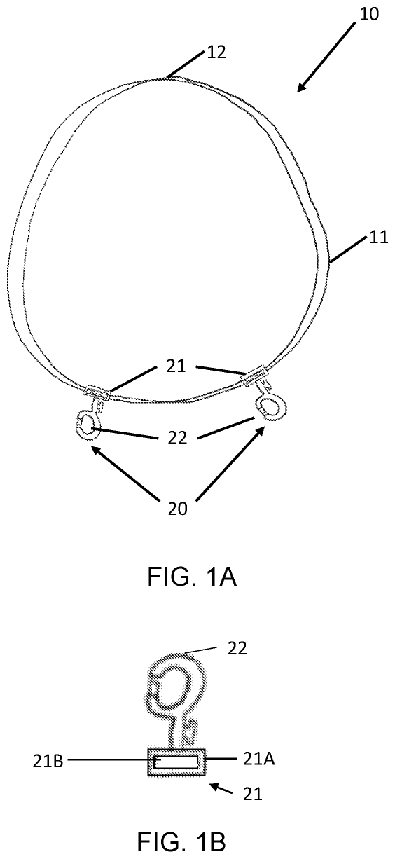

FIG. 1A illustrates an example pet leash that enables multiple dogs to be walked with ease.

The pet leash is designed to allow a user to walk one or more pets at the same time without the leash getting twisted. Referring to FIGS. 1A and 1B, the leash 10 can include a track portion 11, an optional handle portion 12, and, depending on the number of pets, one or more connectors, such as pet connectors 20. In the example shown in FIG. 1A, each of the connectors 20 may include a sliding portion 21 and a gripping portion 22. In an example, as shown in FIG. 1B, the sliding portion 21 may include a body 21A having an opening 21B. The opening 21B may include dimensions sufficiently large enough to slidably receive track 11 such that when a pet is connected to one of the connectors 20 and moves, the connector 20 can slide on the track 11 as the pet moves.

In an example, to construct the pet leash 10, the track 11 is inserted into the opening 21B before the track 11 is turned into a continuous loop. A grip (not show in the FIGS.) can then be attached to a portion of the track 11 to create gripping portion 22. This construction allows each of the connectors 20 to slide along the track 11, without them falling from the track 11. In another example, the sliding portion 21 of the connector 20 can include a design such that each of the connectors 20 can removably slide along track 20. In this example, a side of the sliding portion 21 in include a hinge that would allow the bottom of the sliding portion 21 to open and have the opening 21B be place around the track 11. A user can then close the bottom portion to removably and slidably secure connector 20 to the track 11.

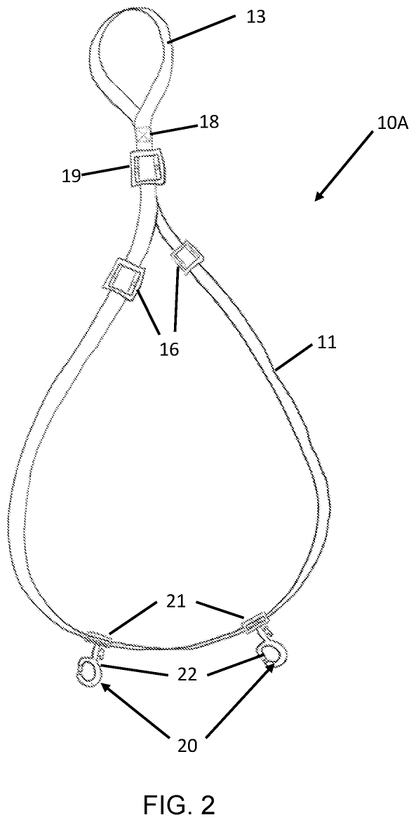

FIG. 2, illustrates an example pet leash 10A that includes a handle 13 that is attached to the track 11. The handle 13 may be created by connecting two portions of the track 11 to one another. For example, as shown in FIG. 2, two portions of the track 11 may be connected to one another by stitching 18. However, any known method may be used to connect two portions of the track 11 to one another. Additionally, the handle 13 can be connected to the track 11 by any method known to one skilled in the art. For example, the handle 13 can be connected to attached to track 11 by stitches, clips, hooks and corresponding rings, swivel connector, etc. Some exemplary connecting methods and devices are further described below.

The pet leash 10A may also include a length adjustor 19 and optional stops 16. In an example, when a user or owner of two or more pets would like to limit the distance in which each pet can be apart, the user can slide and lock the length adjustor 19 at a certain distance away from the handle 13. Thereby, the user shortens the track 11 in which each of the connectors 20 can slide on track 11, thereby, limiting the distance at which each of the plurality of pets can move away from one another during their walk. In one example, the track 11 may also include one or more stoppers 16. The purpose of the stoppers 16 is to limit the movement of the length adjustor 19 so that a user is unable to limit the movements of the two pets, such that they are uncomfortably close to one another. In one example, each of the stoppers 16 can be movably adjusted. In another example, each of the stoppers 16 are permanently positioned and cannot be adjusted.

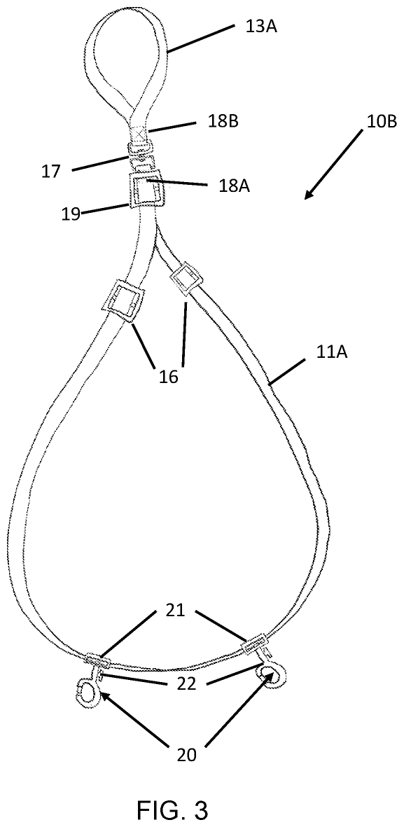

FIG. 3, illustrates an example pet leash 10B that includes a handle 13A that is connected to track 11A via swivel 17. In this example, the track 11A includes a first end and a second end that come together and attach to one end of the swivel 17. The handle 13A may also include a first end and a second end that come together and attached to a second end of the swivel 17. In an example, the two ends of the handle 13A are first connected to one another via stitching 18A. The single end is then connected to the second end of the swivel 17. Similarly, the two ends of the track 11A can first be connected to one another via stitching to create a single end and the single end of the track 11A can then be connected to the first end of the swivel 17. The swivel 17 can provide an advantage when one of the plurality of pets (not shown in the FIGS.) crosses another pet. When one pet crosses another pet, the swivel 17 allows the track 11A and the connectors 20 to flip with respect to the handle 13A, thereby circumventing the need for the user to flip the handle 13A to prevent the track 11A from tangling or intertwining around itself.

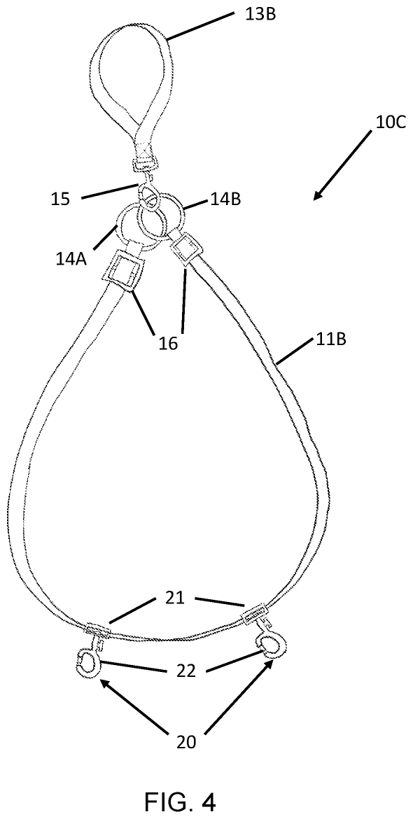

FIG. 4, illustrates an example of a pet leash 10C that includes a detachable handle 13B. In this example, the swivel 17 of FIG. 3 has been replaced by a connector 15. Each end of track 11B may be connected to a corresponding ring or loop 14A and 14B. This design allows the user to detach one end of the track 13B from the connector 15, thereby doubling the length of the track in which a pet can lead.

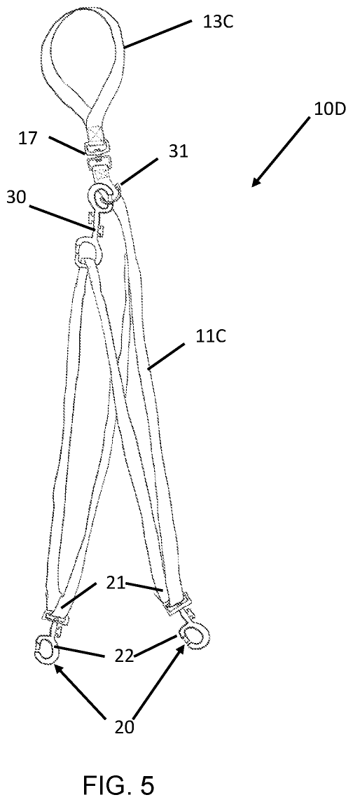

In another example, as shown in FIG. 5, the pet leash 10D can include a ring, such as D-ring 31. The D-ring 31 can be positioned anywhere on a track 11C. As shown in FIG. 5, the D-ring 31 may be positioned near or approximate to a handle 13C. The purpose of the D-ring 31 is to reduce the length of the track 11C by connecting a portion of the track 11C onto the D-ring. In an example, as shown in FIG. 5, a hook 30 may be used to connect a portion of the track 11C onto the D-ring 31. In another example, not shown in the FIGS., one end of the hook 30 includes a D-ring that is attached to the track 11C and replaces the D-ring 31. In this example, there is no need to have a separate D-ring 31.

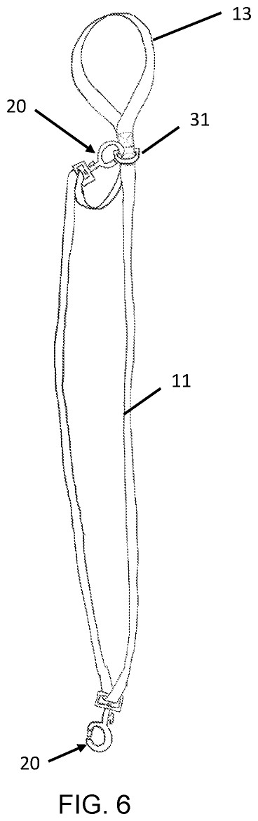

In another example, as shown in FIG. 6, if a user is planning to only walk one of the plurality of the pets, the user can attached any unused connectors 20 on to the D-ring 31. Similar to FIG. 5, the D-ring 31 of FIG. 6 can be positioned anywhere on the track 11. For example, the D-ring 31, can be positioned near or approximate to a handle 13.

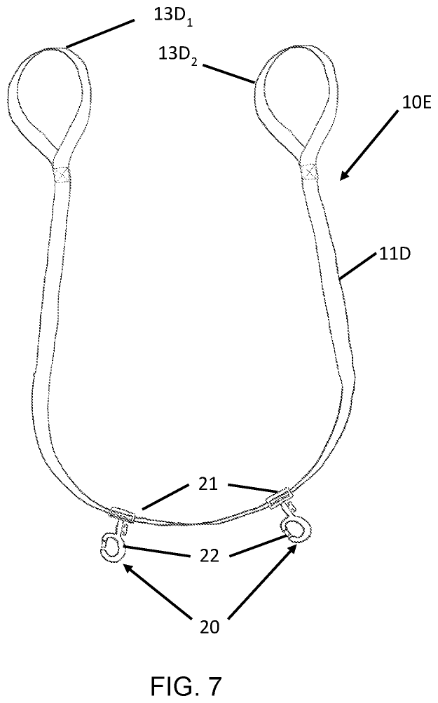

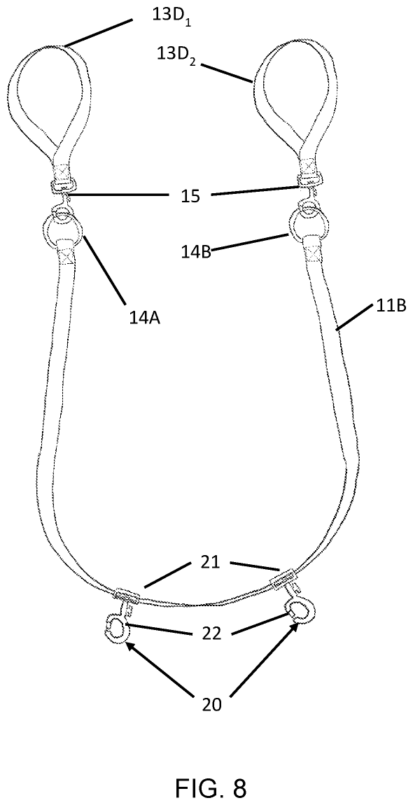

In another example, as shown in FIG. 7, the pet leash 10E can include a track 11D having a first end, a second end, and a corresponding first handle 13D₁ and 13D₂. As shown in FIG. 7, each of the handles 13D₁ and 13D₂ can be an extension of track 11D. Alternatively, as shown in FIG. 8, each of the handles 13D₁ and 13D₂ can be removably connected to each end of track 11B via ring or loop 14A and 14B. In this example, the pet leash 10E can be converted to a single handle pet leash as shown in FIG. 4.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

We claim:

1. A pet leash comprising:
a track including a first end and a second end; and
at least one pet connector including a hook portion and a slider portion that enables the pet connector to move freely along the track.

2. The pet leash of claim 1, wherein the first end and the second end of the track are connected to one another.

3. The pet leash of claim 2, wherein the first end and the second end of the track are connected to one another via stitching, clips, detachable rings, connector and a corresponding ring, or a combination thereof.

4. The pet leash of claim 1, wherein the at least one pet connector comprises first pet connector and a second pet connector to create a multi-pet leash.

5. The pet leash of claim 4, wherein one of the first or second pet connectors is removably attached to a portion of the multi-pet leash to convert the multi-pet leash to a single pet leash.

6. The pet leash of claim 1, wherein the slider allows a pet connected to the hook portion of the connector to move freely along the track.

7. The pet leash of claim 1 further comprises at least one handle.

8. The pet leash of claim 7, wherein the at least one handle is part of the track.

9. The pet leash of claim 7, wherein the at least one handle is separate from the track and is connected to the track by stitch, clip, hook and corresponding ring, swivel connector, or a combination thereof.

10. The pet leash of claim 1, wherein each of the first end of the track includes a first handle and the second end of the track includes a second handle.

11. The pet leash of claim 10, wherein each of the first handle and the second handle is formed as part of the first end of the track and second end of the track, respectively.

12. The pet leash of claim 10, wherein each of the first handle and the second handle is separate from the track and is connected to its respective first and second end of the track by stitch, clip, hook and corresponding ring, swivel connector, or a combination thereof.

13. The pet leash of claim 1, further comprising a stopper that limits the movement of the at least one pet connector on the track.

14. The pet leash of claim 1, further comprising a length adjustor.

15. The pet leash of claim 14, wherein the length adjustor comprises a device that overlaps or connects two portions of the track to one another.

16. The pet leash of claim 14, wherein the length adjustor is a buckle, a zipper, elastic band, or a combination thereof.

17. A multi-pet leash comprising:
a track portion;
a handle portion; and
at least two connectors, wherein at least one of the two connectors is a slidable connector.

18. The multi-pet leash of claim 17 further comprising at least one stopper.

19. A multi-pet leash comprising:
a track portion having a first end and a second end; and
a handle associated with each of the first end and the second end.

20. The multi-pet leash of claim 19 further comprising:
at least two connectors, wherein at least one of the two connectors is a slidable connector.
